(19) United States
(12) Patent Application Publication
(10) Pub. No.: US 2004/0050594 A1
(43) Pub. Date: Mar. 18, 2004

(54) Supplemental weight for balancing scale

(76) Inventor: Ted A. Tobey, Carmel, CA (US)

Correspondence Address: PATRICK REILLY, BOX 7218, SANTA CRUZ, CA, 95061-7218, US

(21) Appl. No.: 10/242,510

(22) Filed: Sep. 12, 2002

(51) Int. Cl. G01G 23/01

(52) U.S. Cl. 177/128; 177/171; 177/264; 73/1.13; 177/191; 177/192

(57) ABSTRACT

An apparatus and technique that extend the useful weighing range of a weight scale is provided. A preferred embodiment comprises a screw and a moveable weight. A head of the screw fits into a notch on the weight scale and the location moveable weight is varied in relation to the screw head by driving the screw into or away from the center of the moveable weight via a tapped receiver of the moveable weight. In a second embodiment, a supplemental weight has a base and a movable weight that are associated and positionally adjustable along at least one linear axis. In a preferred embodiment, a threaded screw length is used to adjust the relative positions of the base and the movable weight. The supplemental weight is removably coupled with the weight scale and calibrated into an operating state, wherefrom the weighing range of the scale may be extended.

### FIELD OF THE INVENTION

The present invention relates to the systems and methods used to determine the weight of persons and objects. More particularly, the present invention relates to scale using balancing weights to determine or measure the weight of a person or object.

### BACKGROUND OF THE INVENTION

Balancing weight scales, such as a DETECTO MODEL 339 PHYSICIAN SCALE balance weight scale, are widely used to weigh goods and in medical settings and schools to obtain patient and student body weights. Many of these scales are quite rugged and have long lifespans. However, with the growing incidence of obesity in this country, it is becoming common for a medical clinic to have patients who are too heavy to be weighed on an industry standard balance weight scale. On occasion patients are required to weigh themselves off-site from a medical clinic and on an industrial scale, or a butcher's or livestock scale. Sending patients to an off-site scale is an operational burden on most medical clinics or schools, and asking a patient to weigh himself or herself on a scale designed for livestock or meat is uncomfortable, to say the least, for all involved.

In the United States, many balance weight scales deployed for weighing human beings top off at 350 pounds of weight measurement range. Extending the measuring range of this population of weight scales without requiring the purchase of a new weight balance scale would be convenient in most situations.

A supplemental weight that can be used as an after market option for several weight scale systems of the same make and model, or for weight scales of certain different makes and models, should be adjustable to fit the balancing characteristics of a specific weight scale. It is an object of the present invention to provide a supplemental weight that can be adjusted to extend the weight measuring range of certain weight balance scales.

### SUMMARY OF THE INVENTION

The method of the present invention provides an apparatus and technique that expand the range of weight that a weight scale can measure and can be adjusted to be useful with a particular weight scale. This and other objects and advantages of the present invention are achieved by providing a supplemental weight.

Many weight scales have two arms and two positioning weights. A first positioning weight is moved along a first arm, the first arm having notches. The first weight is registered at a given position along the first arm by dropping an extension of the positioning weight into a selected notch. In this way the positioning weight can counterbalance selected weights, such as 50 pounds, 100 pounds, and up to, say 300 pounds in 50-pound increments. A second weight is slidably movable along a second arm across a balancing range equal to the magnitude of the weight increments of the first arm, e.g. 50 pounds.

A first preferred embodiment of the present invention, or supplemental weight, uses the notches of the first weight scale arm to removably couple the supplemental weight with the weight scale arm. The supplemental weight has a mass and comprises a moveable weight and an adjusting member. The adjusting member is moveably attached to the moveable weight, and has a coupling element. The adjusting member of the coupling element is sized and fitted to allow and operator to couple the supplemental weight to the weight scale in a location relative to at least one notch of the weight scale arm. The adjusting member may have a threaded screw length that engages with a tapped receiver of the moveable weight. The threaded screw length is driven into or away from a center or axis of the moveable weight in order to adjust the relative position of the moveable weight and the adjusting member. The threaded screw length may have a head that is sized and fitted to removably couple with at least one notch of the weight scale arm.

In an alternate preferred embodiment of the present invention, or second design, the supplemental weight comprises a base and a movable weight. The second design is shaped and fitted to be removably coupled with a portion of the weight scale. The base is sized and fitted to rest upon or be attached to the weight scale portion. The relative positions of the base and the movable weight are adjustable along at least one linear axis. The adjustment of the relative positions of the base and the movable weight is accomplished, in whole or in part, in various preferred embodiments of the present invention by motorized, manual, mechanical, electrical, magnetic, electromagnetic, electromechanical methods or means, or other suitable methods or means known in the art.

The method of the present invention teaches that the weight scale may be placed into a predetermined calibration state prior to calibrating the present invention. A weight may then be placed upon a weighing stage of the weight scale. The weight should weigh more than the desired expansion of weighing range of the weight scale. The supplemental weight, being removably coupled with the weight scale, is adjusted until the weight scale is placed into a balancing state. The adjustment of the supplemental weight may include adjusting the relative positions of the movable weight and the base, or alternatively the adjusting member, until the weight scale is placed into the balanced state. This adjustment places the supplemental weight into an operating state. The supplemental weight may then be stored in the operating state.

Certain alternate preferred embodiments of the present invention further comprise storing the supplemental weight close to the weight scale by mechanical and/or magnetic means or methods, or other suitable means or methods known in the art. Alternatively or additionally, certain alternate preferred embodiments include a knob coupled with the adjusting member or base to allow the operator to manually rotate the threaded screw length and thereby change the relative position of the moveable weight and the base or the adjusting member.

The foregoing and other objects, features and advantages will be apparent from the following description of the second design of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is an illustration of a first preferred embodiment of the present invention with a weight scale.

FIG. 2 is a detailed illustration of a first preferred embodiment of the present invention in operational use on the weight scale of FIG. 1.

FIG. 3 is an illustration of the first preferred embodiment of the present invention of FIG. 1 with an optional knob.

FIG. 4 is a schematic diagram of a second preferred embodiment of the present invention, or second design.

FIG. 5 is a schematic drawing of the second design of FIG. 4 with an optional motor.

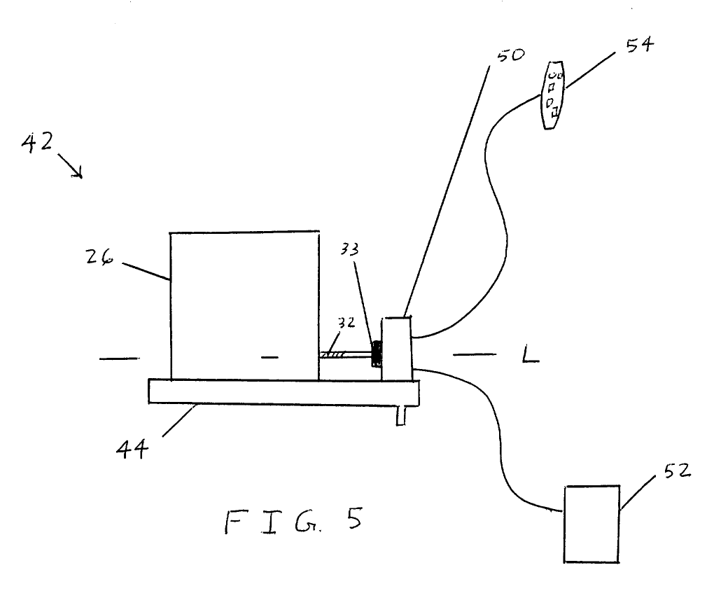

FIG. 6 is detailed set of views with dimensional measurements of an additional preferred embodiment of the moveable weight of FIG. 2.

### DETAILED DESCRIPTION OF THE SECOND DESIGN

In describing the preferred embodiments, certain terminology will be utilized for the sake of clarity. Such terminology is intended to encompass the recited embodiment, as well as all technical equivalents which operate in a similar manner for a similar purpose to achieve a similar result.

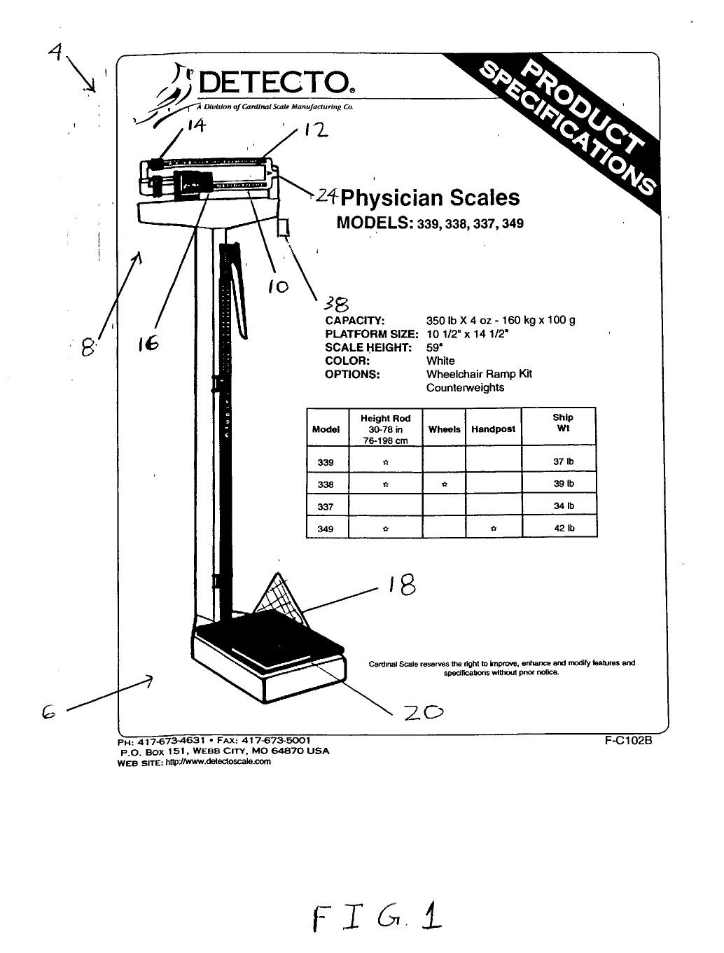

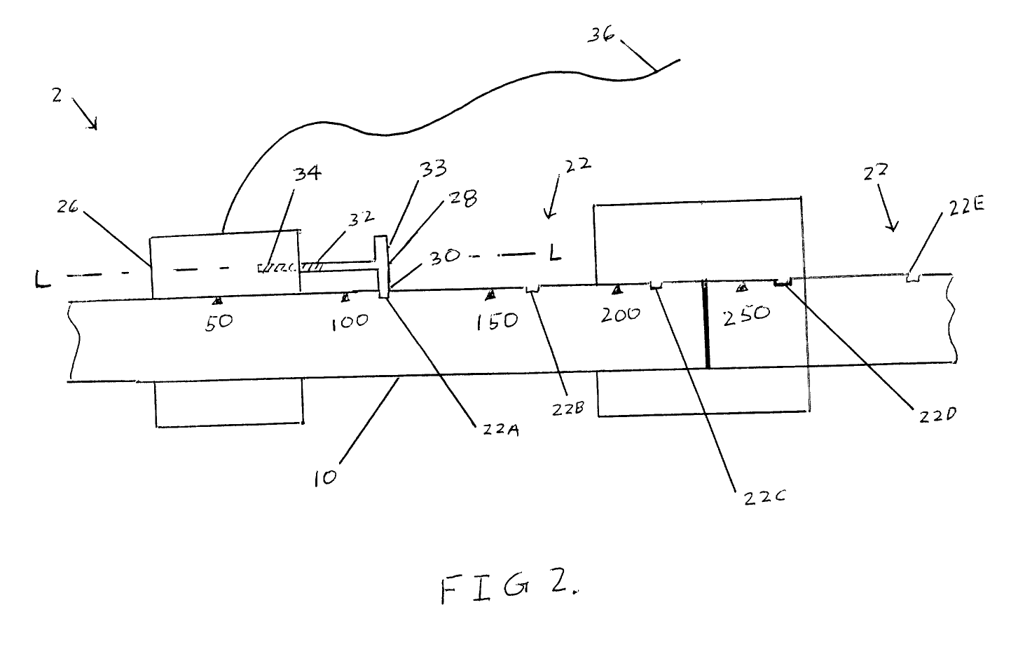

Referring now generally to the Figures and particularly to FIGS. 1 and 2, a first preferred embodiment of the present invention 2, or supplemental weight 2, is removably coupled onto a weight scale 4. The weight scale 4 has a weighing section 6 and a balance weights structure 8. The balance weights structure 8 includes a lower balance arm 10 and an upper balance arm 12. A positional light balance weight 14 and heavy balance weight 16 are moved by an operator to create a balance within the weight scale 4 and a weight 18, or a person, placed upon a weighing stage 20 of the weighing section 6. The lightweight 14 is manually moved along the upper arm 12 by an operator. The heavy balance weight 16 is selectably located by the operator at one of a discrete set of locations along the lower arm 10 remain substantially visible through the heavy balance weight 16. Please note, that for the purposes of explanation, the heavy balance weight 16 is illustrated in FIG. 2 as though it were substantially transparent and the features of the lower arm Registration features 22, or notches 22, of the lower arm 10 are used to repeatabley and accurately position the heavy balance weight 16 to create a balance between the balance weights 14 and 16 and the weight 18. Certain alternate preferred embodiments of the present invention are adapted to removabley couple with other suitable registration features known in the art other than notches, and where the alternate suitable registration features known in the art are used to repeatabley and accurately locate the heavy balance weight 16 along a balancing arm 10 of a weight scale 4. The light balance weight 14 is used to more finely tune balancing between the balance weights 14 and 16 and the weight 18. The establishment of a balanced state between the balance weights 14, 16 is determinable by observing when an indicator 24 of the balance weights structure 8 is substantially parallel with the Earth's surface and stationary. In the example weight scale 4 of FIG. 1, the notches 22 are positioned to allow the heavy balance weight 16 to balance against weights of 50 pounds, 100 pounds, 150 pounds, 200 pounds, 250 pounds and 300 pounds. The light balance weight 14 may be positioned to create a balance with a weight 16 between zero and 50 pounds, whereby the maximum weight that the weight scale 4 can measure, as configured by the manufacturer, is 350 pounds.

Persons weighing more than 350 pounds cannot therefore be weighed on the weight scale 4. The method of the present invention enables the supplemental weight 2 to expand the range of weight that the weight scale 4 can measure. The supplemental weight 2 is sized and fitted to be removably coupled with the lower arm 10. A moveable weight 26 of the supplemental weight 2 provides a balancing weight to the weight 18 when the supplemental weight 2 is coupled with the lower arm 10. An adjusting member 28 of the supplemental weight 2 has a coupling element 30. The coupling element 30 is sized and fitted to sit into each of the notches 22 of the lower arm 10. In using the supplemental weight 2, the operator moves the heavy balance weight 16 to the 250 pound position, and by using notch 22E, or the 300 pound position (not shown), to allow the supplemental weight 2 to be removably placed upon the lower arm 10. The operator then places the coupling element 30 onto the 50-pound notch 22A and thereby applies the weight of the supplemental weight 2 in balancing against the weight 16.

The method of the present invention teaches that the supplemental weight 2 may be placed into a calibration state prior to using the supplemental weight 2 to weigh a person or object. In the example of FIGS. 1 and 2, the supplemental weight 2 may be calibrated by placing a weight greater than 250 pounds but less than 300 pounds on the weighing stage 20. Supposing that the weight 18 weighs within this range of 250 pounds to 300 pounds, the weight 18 is then balanced by placing the heavy balance weight 16 at the 250-pound location and adjusting the light balance weight 14 along the upper arm 12 to fine tune the counter balance created with the heavy balance weight 16. Once balance is achieved, the heavy balance weight 16 is then moved to the 200-pound location and the supplemental weight 2 is adjusted. The supplemental weight 2, being removably coupled with the weight scale, is adjusted until the weight scale 4 is returned into a balancing state against the weight 16.

Referring now generally to the Figures and particularly to FIGS. 1 and 2, the adjustment of the supplemental weight 2 may include adjusting the relative positions of the movable weight 26 and the adjusting member 28 until the weight scale 4 is placed into the balanced state. This adjustment places the supplemental weight 2 into an operating state. The supplemental weight 2 may then be stored in the operating state. The adjustment of the supplemental weight 2 employs the rotation of a threaded screw length 32 of the adjusting member 28 within a tapped receiver 34 of the moveable weight 26. The coupling element 30 comprises a head 33 of the threaded screw length 32, and may be slotted to accept a standard screw driver blade, a Phillips screw driver point, or another suitable screw rotating tool or mechanism known in the art. Rotating the threaded screw length 32 about a linear axis L in a first direction drives the threaded screw length 32 further into the moveable weight 26 via the tapped receiver 34, whereby the moveable weight 26 is drawn closer to the coupling element 30 of the adjusting member 28 and the effect of the supplemental weight 2 upon the balancing action of the weight scale 4 is altered. Alternatively, rotating the threaded screw length 32 about the linear axis L in a second direction drives the threaded screw length 32 away from the moveable weight 26 via the tapped receiver 34, whereby the moveable weight 26 is pushed further from the coupling element 30 of the adjusting member 28 and the effect of the supplemental weight 2 upon the balancing action of the weight scale 4 is altered. The supplemental weight 2 is thereby adjusted by rotating the threaded screw length 28 until the indicator 24 is substantially parallel to the Earth's surface and the stationary. At this point the supplemental weight 2 is personalized to the balancing dynamics of the weight scale 4 and is placed into an operating state whereby the supplemental weight 2 may be used to add 50 pounds or range to the weight scale. In the example weight scale of FIG. 1, the supplemental weight 2 may also be sized and fitted to removably couple with the 100 Pound notch 22B and thereby extend the weighing range of the weight scale 4 from 300 pounds to 400 pounds.

A flexible cable 36 moveably secures the supplemental weight 2 to the weight scale 4. Cable 36 is sufficiently long to allow the operator to place the supplemental weight 2 into a holder 38 for storage. Holder 38 is attached to the weight scale 4 and is sized and fitted to substantially house the supplemental weight 2.

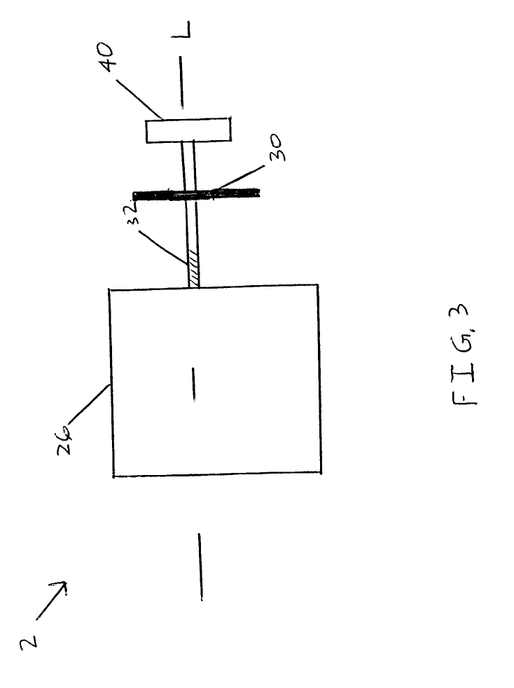

Referring now generally to the Figures and particularly to FIG. 3, the supplemental weight 2 has an optional feature of an adjustment knob 40. The knob 40 is positioned about the axis L to enable the operator to apply force either directly or indirectly to the knob 40, and at a position removed from the coupling element 30, to rotate the threaded screw length 32 about the L axis. Please note that coupling feature 30 is extended beyond the circumference of knob 40 to permit the coupling element 30 to seat into a notch 22 with the knob 40 attached to the supplemental weight 2. In certain alternate preferred embodiments of the present invention, the operator may optionally rotate the knob 40 by means of a suitable tool such as a suitable screwdriver, or other suitable mechanism known in the art.

The supplemental weight 2 may be or comprise a suitable metal, e.g. aluminum or iron, or another suitable material of sufficient density. Additionally or alternatively, the supplemental weight 2 may be magnetic or be responsive to magnetic charges. The optional magnetic properties of certain alternate preferred embodiments of the present invention may be useful in removably coupling the supplemental weight 2 with the weight scale 4, or in more firmly storing the supplemental weight 2 in the holder 38. The supplemental weight 2 may be, in certain preferred embodiments, on the order of 200 grams to 250 grams, and fit within a dimensional design envelope of cube of three inches by three inches by three inches.

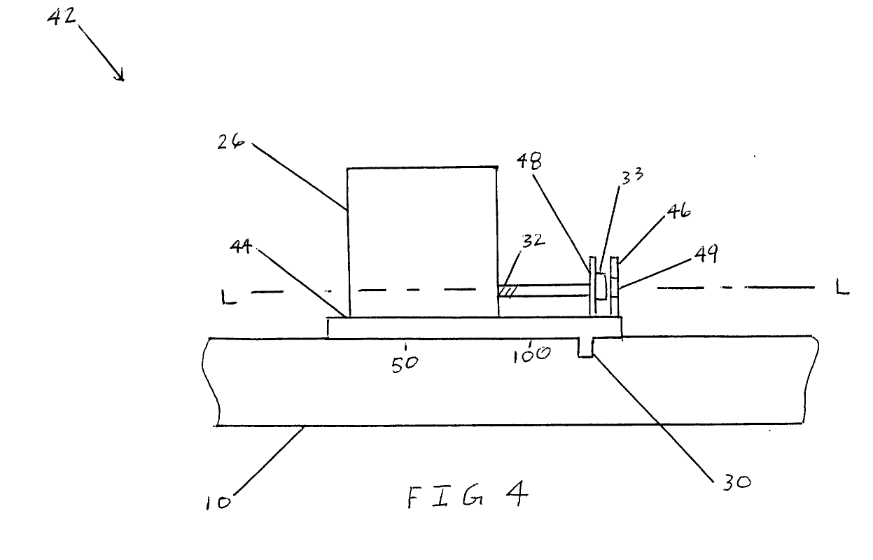

Referring now generally to the Figures and particularly to FIG. 4, a second preferred embodiment of the present invention 42, or second design 42, is removably coupled onto the weight scale 4. The second design 42 is sized and fitted to be removably coupled with the lower arm 10 of the weight scale 4. The moveable weight 26 and a base 44 of the second design 42 provides a balancing weight to the weight 18 when the second design 42 is coupled with the lower arm 10. The moveable weight 26 rests upon the base 44. The base 44 of the second design 42 has a coupling element 30. The coupling element 30 is sized and fitted to sit into an individual notch 22 selected from the plurality of notches 22 of the lower arm 10. As noted above, the moveable weight 26 rests upon the base 44 and the weight of the second design 42 is borne down upon the lower arm 10 via the base 44. In using the second design 42, the operator moves the heavy balance weight 16 to the 200 pound position, and by using notch 22D, and thereby allows the second design 42 to be removably placed upon the lower arm 10. The operator then places the coupling element 30 onto the 50-pound notch 22A or the 100-pound notch 22B and thereby applies the weight of the second design 42 in balancing against the weight 16.

The method of the present invention teaches that the second design 42 may be placed into a calibration state prior to using the second design 42 to weigh a person or object. In the example of FIG. 4, the second design 42 may be calibrated by placing a weight greater than 250 pounds but less than 300 pounds on the weighing stage 20. Supposing that the weight 18 weighs within this range of 250 pounds to 300 pounds, the weight 18 is then balanced by placing the heavy balance weight 16 at the 250 pound location and adjusting the light balance weight 14 along the upper arm 12 to fine tune the counter balance with the weight 16. Once balance is achieved, the heavy balance weight 16 is then moved to the 200-pound location and the second design 42 is coupled with the lower arm 10 and is adjusted. The second design 42, being removably coupled with the weight scale, is adjusted until the weight scale 4 is returned into a balancing state against the weight 16. The achievement of a balanced state is confirmed by observing when indicator 24 is substantially parallel to the Earth's surface and stationary.

Referring now generally to the Figures and particularly to FIGS. 4 and 1, the adjustment of the second design 42 into an operating state may include adjusting the relative positions of the movable weight 26 and the base 44 until the weight scale 4 is placed into the balanced state. The second design 42 may then be stored in the operating state. The adjustment of the second design 42 employs the rotation of the threaded screw length 32 of the base 44 within the tapped receiver 34 of the moveable weight 26. The head 33 of the threaded screw length 32 is turned by the operator either manually or with a suitable tool known in the art. The head 33 may be slotted to accept a standard screw driver blade, a Phillips screw driver point, or another suitable screw rotating tool or mechanism known in the art. The head 33 is captured within the base 44 by an outer wall 46 and an inner wall 48. Outer wall 46 has an aperture 49 through which the screw head 33 is accessible for rotation. Rotating the threaded screw length 32 about a linear axis L in a first direction drives the threaded screw length 32 further into the moveable weight 26 via the tapped receiver 34, whereby the moveable weight 26 is drawn closer to the coupling element 30 of the base 44 and the effect of the second design 42 upon the balancing action of the weight scale 4 is altered. Alternatively, rotating the threaded screw length 32 about the linear axis L in a second direction causes the threaded screw length 32 to drive the moveable weight 26 away from the base 44, whereby the moveable weight 26 is pushed further from the coupling element 30 of the base 44 and the effect of the second design 42 upon the balancing action of the weight scale 4 is altered. The second design 42 is thereby adjusted by rotating the threaded screw length 28 until the indicator 24 is substantially parallel to the Earth's surface and the stationary. At this point the second design 42 is personalized to the balancing dynamics of the weight scale 4 and is placed into an operating state whereby the second design 42 may be used to add 50 pounds of weight range to the weight scale. In the example weight scale of FIG. 4, the second design 42 may also be sized and fitted to removably couple with the 100 Pound notch 22B and thereby extend the weighing range of the weight scale 4 from 350 pounds to 450 pounds.

A flexible cable 36 moveably secures the second design 42 to the weight scale 4. Cable 36 is sufficiently long to allow the operator to place the second design 42 into a holder 38 for storage. Holder 38 is attached to the weight scale 4 and is sized and fitted to substantially house the second design 42.

The second design 42 may be or comprise a suitable metal, e.g. aluminum or iron, or another suitable material of sufficient density. Additionally or alternatively, the second design 42 may be magnetic or be responsive to magnetic charges. The optional magnetic properties of certain alternate preferred embodiments of the present invention may be useful in removably coupling the second design 42 with the weight scale 4, or in more firmly storing the second design 42 in the holder 38. The second design 42 may be, in certain preferred embodiments, on the order of 200 grams to 250 grams, and fit within a dimensional design envelope of cube of three inches by three inches by three inches.

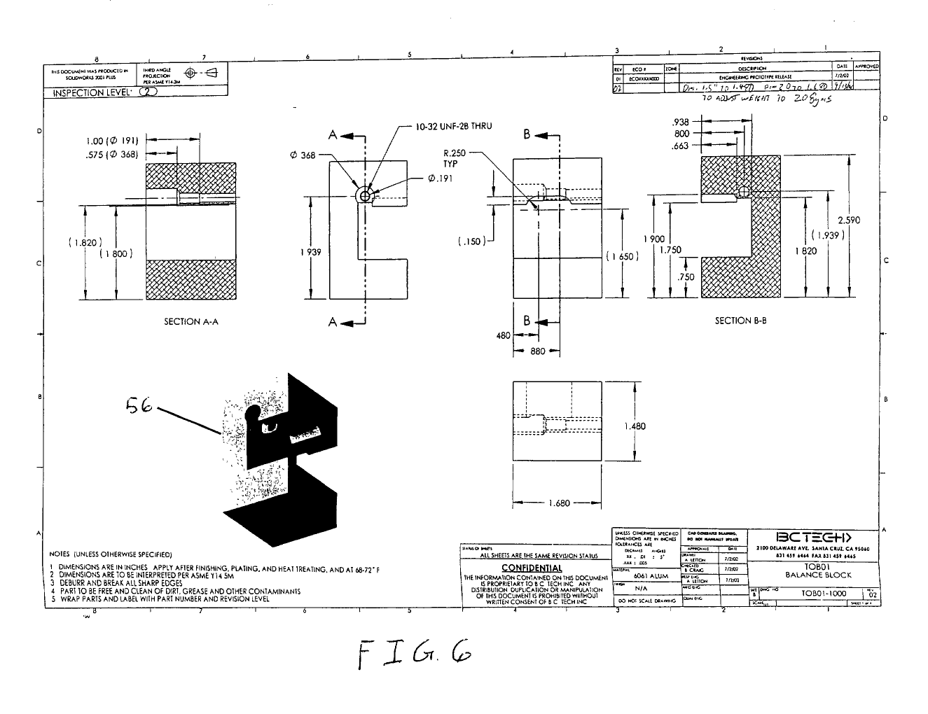

Referring now generally to the Figures and particularly to FIG. 6, a motor 50 is coupled with the screw head 33 of the second design 42. The motor 50 is powered by power supply 52 and the state of the motor 50 is controlled by the control unit 54. The operator uses control unit 54 to vary the state of the motor 50 and thereby control the rotation or non-rotation of the threaded screw length and thereby control the relative position of the moveable weight 26 and the base 44.

FIG. 6 is detailed set of views with dimensional measurements of an additional preferred embodiment 56 of the moveable weight 26 of FIG. 2.

Those skilled in the art will appreciate that various adaptations and modifications of the just-described preferred embodiments can be configured without departing from the scope and spirit of the invention. Therefore, it is to be understood that the invention may be practiced other than as specifically described herein.

I claim:

1. A supplemental weight, the supplemental weight for coupling with a weight balancing scale, the scale having at least one registration feature, the supplemental weight comprising:
a moveable weight;
an adjusting member, the adjusting member moveably coupled with the moveable weight, and the adjusting member having a coupling element, the coupling element sized and fitted to couple the supplemental weight to the weight balancing relative scale relative to at least one registration feature of the moveable weight scale.

2. The supplemental weight of claim 101, wherein the adjusting member further comprises a threaded screw length, and the moveable weight comprises a tapped receiver, the tapped receiver sized and fitted to mechanically engage with the threaded screw length, whereby the position of the movable weight in relation to the adjusting member is adjusted along a linear axis by driving the threaded screw length within the tapped receiver.

3. The supplemental weight of claim 2, wherein the supplemental weight further comprises a set screw and the moveable weight comprises a tapped set screw passage, the set screw for passing at least partially through the moveable weight and for pressing against the adjusting member and thereby maintaining the supplemental weight in an operating state.

4. The supplemental weight of claim 1, wherein the threaded screw length comprises an adjustment knob, the adjustment knob for use by a user to rotate the threaded screw length about the linear axis and to change the relative position of the base and the movable weight.

5. The supplemental weight of claim 1, wherein the supplemental weight is sized and fitted for removable coupling with the weight balance scale.

6. The supplemental weight of claim 1, wherein the supplemental weight further comprises magnetically responsive material.

7. The supplemental weight of claim 6, wherein the magnetically responsive material generates a magnetic field.

8. The supplemental weight of claim 1, wherein the supplemental weight further comprises a holder, the holder for securing the supplemental weight when the supplemental weight is removed from the weight balance scale.

9. The supplemental weight of claim 8, wherein the holder is attached to the weight balance scale.

10. The supplemental weight of claim 1, wherein the supplemental weight further comprises a motor, the motor for altering the relative position of the base and the movable weight.

11. The supplemental weight of claim 2, wherein the supplemental weight further comprises a motor, the motor coupled with the threaded screw length and for rotating the threaded screw length and thereby adjusting the relative position of the base and the movable weight.

12. A supplemental weight for coupling with a weight balancing scale, the supplemental weight comprising:
a base, the base sized and fitted for coupling with the weight balancing scale; and a movable weight, the movable weight slidably coupled with the base, whereby the movable weight is placed into an operating location and the supplemental weight is maintained in an operating state, and a weighing range of the weight balancing scale is increased when the base is coupled with the weight balancing scale.

13. The supplemental weight of claim 12, wherein the base is sized and fitted to rest upon a portion of the weight balancing scale.

14. The supplemental weight of claim 12, wherein the base comprises a threaded screw length and the moveable weight comprises a threaded receiver, the threaded screw length engaging the threaded receiver of the movable weight and the threaded screw length for moving the movable weight in relation to the base by rotating the threaded screw length about a linear axis.

15. The supplemental weight of claim 14, wherein the supplemental weight further comprises a set screw, the set screw for pressing against the threaded screw length and for maintaining the supplemental weight in an operating state.

16. The supplemental weight of claim 14, wherein the threaded screw length comprises an adjustment knob, the adjustment knob for use by a user to rotate the threaded screw length about the linear axis and change the relative position of the base and the movable weight.

17. The supplemental weight of claim 12, wherein the supplemental weight is sized and fitted for removable coupling with the weight balance scale.

18. The supplemental weight of claim 12, wherein the supplemental weight further comprises an attachment element, the attachment element for coupling the supplemental weight to the weight balance scale.

19. The supplemental weight of claim 12, wherein the supplemental weight further comprises magnetically responsive material.

20. The supplemental weight of claim 19, wherein the magnetically responsive material generates a magnetic field.

21. The supplemental weight of claim 20, wherein the supplemental weight further comprises a holder, the holder for securing the base when the base is removed from the weight balance scale.

22. The supplemental weight of claim 21, wherein the holder is attached to the weight balance scale.

23. The supplemental weight of claim 12, wherein the supplemental weight further comprises a motor, the motor for altering the relative position of the base and the movable weight.

24. The supplemental weight of claim 14, wherein the supplemental weight further comprises a motor, the motor coupled with the threaded screw length and for rotating the threaded screw length and thereby adjusting the relative position of the base and the movable weight.

25. A method for extending the measuring range of a weight balance scale, the method comprising:
Providing a weight balance scale having a balance arm;
Providing a supplemental weight having a mass, the supplemental weight having a coupling feature and a moveable weight, coupling feature and the moveable weight being moveably coupled;
Coupling the supplemental weight to the balance arm and causing the mass of the supplemental weight to drive the balance arm towards the Earth's surface; and
Calibrating the supplemental weight to providee a desired magnitude of weight counterbalance to the weight scale, the calibrating of the supplemental weight accomplished by adjusting the relative position of the coupling feature and moveable weight to achieve the desired magnitude of weight counterbalance.
